(19) United States
(12) Patent Application Publication
(10) Pub. No.: US 2007/0058560 A1
(43) Pub. Date: Mar. 15, 2007

(54) NETWORK DEVICE, AND DATA PROCESSING METHOD

(75) Inventor: Masahiko Sakai, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/468,990

(22) Filed: Aug. 31, 2006

(30) Foreign Application Priority Data
Sep. 13, 2005 (JP) 2005-265907

(51) Int. Cl. H04J 1/16

(52) U.S. Cl. 370/252

(57) ABSTRACT

There is provided a device which comprises: a reception unit adapted to receive a specific request transmitted from an information processing device on a network; a judgment unit adapted to judge whether or not setting concerning the network in the device has been changed; and a control unit adapted to not execute a process for the specific request received by the reception unit in a case where it is judged by the judgment unit that the setting concerning the network has been changed, and to execute the process for the specific request received by the reception unit in a case where it is judged by the judgment unit that the setting concerning the network is not changed.

### BACKGROUND OF THE INVENTION

1. Field of the Invention

The present invention relates to a network device and a data processing method. More particularly, the present invention is suitable to be used in a case where an information processing device and a network device transmit and receive data through a network.

2. Description of the Related Art

In recent years, an LAN (local area network) in which plural computers are mutually connected has come into wide use. Incidentally, the relevant LAN can be constructed on a floor of a building, a whole building, a group of buildings (i.e., premises), an area, or a further wider area. Moreover, the relevant LAN can be connected to another LAN, other LAN's, or a global network such as the Internet.

In any case, there is a case where each LAN mutually connected to another LAN in the manner as above has various hardware interconnection techniques and several network protocols. Here, the simply constructed LAN which is separated from another LAN can be managed by an individual user. In other words, the user can exchange a device in the LAN, installs software, and diagnose occurred problems.

On the other hand, in a LAN group which is constructed by a large-scale and complicated LAN, or, in a large-scale LAN group which is constructed by mutually connected plural LAN's, so-called “management” is necessary. Here, it should be noted that “management” here implies the management which is executed by both a network administrator (i.e., human) and the software that the relevant network administrator uses. In the following, it should be noted that “management” implies the management which is executed by using the network management software of managing a whole system, and “user” implies a person who uses the network management software. Moreover, it should be noted that the relevant user is typically a system management responsible person, and that the user can acquire and change management data through a network by using the network management software.

The large-scale network system is typically achieved as a dynamic system which is requested to constantly update the network management software of controlling and managing addition and elimination of network devices, detect various problems, and the like. In general, as the large-scale network systems, there are various systems which are owned by various persons, or various systems which are supplied by various traders, manufacturers and the like. In the LAN like this, an individual network device is discriminated, controlled and managed based on the network address (simply called “address” hereinafter) which is peculiar to each network protocol.

However, in a case where a certain network device is first connected to a network, or, in a case where a network device is reset, the address of the relevant network device is often not yet set, or the set address is often invalid. Here, it should be noted that the case where the network device is first connected to the network implies, for example, a case where the network device which was shipped from a factory is directly and immediately connected to the network. Consequently, in the above cases, it is necessary for a user to set an arbitrary address for the network device by using the network management software or the like.

Incidentally, in case of setting the address of the network device (for example, a printer) by using the network management software, some kind or another network protocol is necessary so that the network management software and the network device mutually execute communication. However, the network device which is in the shipped state from the factory as described above cannot use a standard address such as an IP (Internet Protocol) address or the like, whereby a standard network management protocol such as an SNMP (Simple Network Management Protocol) or the like cannot be used. For this reason, it is conceivable to adopt a method of fitting to the network device a unique or independent protocol in which an MAC (Media Access Control) address is used as an identifier for discriminating the network device, and of setting an address to the network device by using the fit protocol.

Here, it should be noted that the MAC address implies the physical address which is inherent to a certain network device. Incidentally, if the network to be connected and used is the Ethernet™, the MAC address has the length of six bytes. In such a data structure of the MAC address, the forehand three bytes are allocated for data management under the rule of the IEEE (Institute of Electrical and Electronics Engineers), and the remaining three bytes are allocated for a code which is managed independently by each vendor (that is, managed and controlled so that two MAC addresses do not overlap each other). For this reason, it should be noted that two or more network devices which have the same physical address do not resultingly exist all over the world. In other words, it should be noted that a different physical address is allocated to each of the network devices. In any case, in the Ethernet™, a frame is transmitted and received on the basis of the above-explained physical addresses.

That is, if the independent protocol in which the MAC address is used like this is fit to the network device, the network management software acquires the MAC address of the network device which is connected to the network. Then, the list of the network devices of which the respective MAC addresses have been acquired is displayed so as to cause the user to select the appropriate network device from the displayed list. In other words, as described above, the user selects the objective network device from the list which is displayed by the network management software, the address of the network board which is connected to the relevant network device, also the protocol to be invalidated, and the like.

Moreover, the network management software transmits as a setting packet the setting information based on the content selected by the user to the network board of the objective network device, thereby executing setting of the network board of the relevant network device. That is, if it is possible to once set the valid IP address or the like, it is subsequently possible from the network management software to manage the network device by using the standard network management protocol such as the SNMP or the like.

Incidentally, it should be noted that the network management software which manages the network device connected to the network supports the function for authenticating a device password with respect to each network device. By such authentication of the device password, the user acquires from the network device the device password which has been set on the network board, according to need. Then, only in a case where the device password which was acquired as above conforms to the device password which was input by the user, it is possible to set the relevant network device and the relevant network board to be able to acquire and set the detailed information.

Moreover, if it causes a host computer to set the communication control data which is necessary in the network device, it is possible to inhibit that the setting is changed without limitation on the side of the network device (for example, see also Japanese Patent Application Laid-Open No. H05-048753).

However, in the above-described related art, for example, when the setting is executed based on the independent protocol by using the MAC address, any accessing limitation or restriction by authentication or the like is not executed. For this reason, even after the IP address or the like which is valid to the network device was set, there is a fear that a user who does not have any authority is changes the setting of the network device by using the independent protocol in which the MAC address is used.

### SUMMARY OF THE INVENTION

The present invention has been completed in consideration of such a conventional problem as above. Here, according to a first aspect of the present invention, there is provided a device which comprises a reception unit adapted to receive a specific request transmitted from an information processing device on a network a first judgment unit adapted to judge whether or not setting concerning the network in the device has been changed; and a control unit adapted to not execute a process for the specific request received by the reception unit in a case where it is judged by the first judgment unit that the setting concerning the network has been changed, and to execute the process for the specific request received by the reception unit in a case where it is judged by the first judgment unit that the setting concerning the network is not changed.

Further, according to a second aspect of the present invention, there is provided a data processing method comprising a reception step of receiving a specific request transmitted from an information processing device on a network a judgment step of judging whether or not setting concerning the network in a device has been changed; and a control step of not executing a process for the specific request received in the reception step in a case where it is judged in the judgment step that the setting concerning the network has been changed, and of executing the process for the specific request received in the reception step in a case where it is judged in the judgment step that the setting concerning the network is not changed.

Other features, objects and advantages of the present invention will be apparent from the following description when taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate the embodiments of the present invention and, together with the description, serve to explain the principles of the present invention.

FIG. 1 is a diagram showing an example of the schematic configuration of the network system according to the embodiment of the present invention.

FIG. 2 is a block diagram showing an example of the schematic constitutions of the insides of the network board and the printer, according to the embodiment of the present invention.

FIG. 3 is a diagram conceptually showing an example of the schematic constitution of the control program to be executed on the network board, according to the embodiment of the present invention.

FIG. 4 is a block diagram showing an example of the PC (personal computer) which can operate the network management software, according to the embodiment of the present invention.

FIG. 5 is a block diagram showing an example of the module constitution of the network management software according to the embodiment of the present invention.

FIG. 6 is a diagram conceptually showing an example of the packet header of the packet in the configurator protocol according to the embodiment of the present invention.

FIG. 7 is a diagram conceptually showing an example of the constitution of the data portion of the packet in the configurator protocol according to the embodiment of the present invention.

FIG. 8 is a diagram showing an example of the operations of the network management device and the network device in case of transmitting and receiving the configurator data packet, according to the embodiment of the present invention.

FIG. 9 is a diagram showing an example of the dialog box which is to be displayed while the process for receiving a Discovery response packet is being executed, according to the embodiment of the present invention.

FIG. 10 is a diagram showing an example of the dialog box which includes the MAC addresses of the network boards and the list for setting the network, according to the embodiment of the present invention.

FIG. 11 is a diagram showing an example of the dialog box to be displayed after the network board was selected, according to the embodiment of the present invention.

FIG. 12 is a diagram showing an example of the dialog box to be displayed after the setting of the network in the printer was completed, according to the embodiment of the present invention.

FIG. 13 is a flow chart for explaining an example of the process which is executed by the device management module provided on the network board, according to the embodiment of the present invention.

### DESCRIPTION OF THE EMBODIMENTS

In the following, the embodiments of the present invention will be explained with reference to the attached drawings.

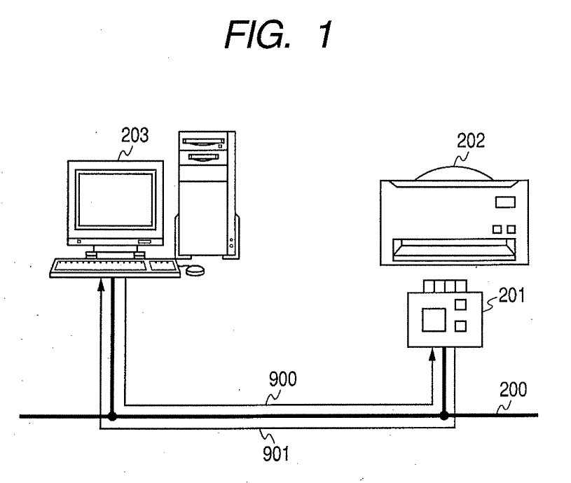

FIG. 1 is a diagram showing an example of the schematic configuration of the network system according to the embodiment of the present invention. In FIG. 1, a LAN 200 is provided as an example of the network, and a network board 201 is provided as an example of the network device which is connected to the LAN 200. Incidentally, it should be noted that the network board 201 is connected to the LAN 200 through an interface such as a 100BASE-T interface having an RJ-45 connector, or the like.

Also, a PC (personal computer) 203 which can communicate with the network board 201 is connected to the LAN 200. The network control program for managing the network works in the PC 203, and the LAN 200 is controlled by the network control program. Incidentally, it should be noted that a request packet 900 and a response packet 901 both shown in FIG. 1 will be later described in detail.

Under normal conditions, the LAN 200 acts as the network for providing various services to a somewhat local user group. For example, a service is provided by using the LAN 200 to a user group on one floor in one building or to a user group on plural continuous floors in one building. Incidentally, if plural users are present in different buildings, a WAN (wide area network) may also be constructed according to the distance between the adjacent users. Here, it should be noted that the WAN is basically constituted by mutually connecting plural LAN's through a high-speed digital line such as an ISDN (Integrated Services Digital Network) or the like. That is, the WAN is the aggregate of the LAN's.

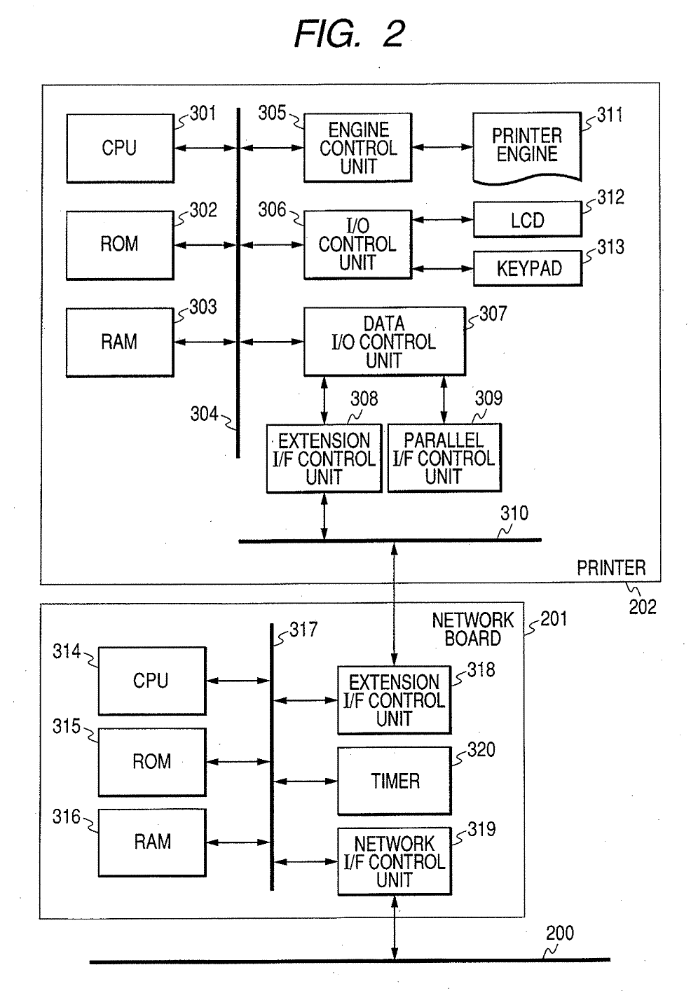

FIG. 2 is a block diagram showing an example of the schematic constitutions of the insides of the network board 201 and the printer 202 both shown in FIG. 1. In FIG. 2, a printer 202 is equipped with a CPU (central processing unit) 301, a ROM (read only memory) 302, a RAM (random access memory) 303, a bus 304, an engine control unit 305, an I/O (input/output) control unit 306, a data I/O control unit 307, an extension I/F (interface) control unit 308, a parallel I/F control unit 309, and an extension board bus 310. Moreover, the printer 202 contains a printer engine 311, an LCD (liquid crystal display) 312 and a keypad 313.

Incidentally, the CPU 301 controls the whole of the printer 202, and the ROM 302 stores therein the control program for controlling the printer 202, and the like. The RAM 303 is used as the working area for the CPU 301, or the like. Further, the CPU 301, the ROM 302, the RAM 303, the engine control unit 305, the I/O control unit 306 and the data I/O control unit 307 are connected to the bus 304. The engine control unit 305 controls the printer engine 311 so that the information input as electronic data is printed as a toner image on a paper. Further, the I/O control unit 306 controls the LCD 312 which displays thereon an image, the keypad 313 which receives and accepts various key inputs, and the like.

The data I/O control unit 307 controls data input and output between the printer 202 and an external device, and also controls the extension I/F control unit 308 and the parallel I/F control unit 309. Incidentally, the extension I/F control unit 308 and the network board 201 are mutually connected to each other through the extension board bus 310.

Besides, the network board 201 is equipped with a CPU 314, a ROM 316, a RAM 316, a bus 317, an extension I/F control unit 318, a timer 320, and a network I/F control unit 319. The CPU 314 controls the whole of the network board 201, and the ROM 315 stores therein the control program for controlling the network board 201, and the like. The RAM 316 is used as the working area for the CPU 314, or the like. Further, the network I/F control unit 319 controls various communications between the network board 201 and the external network, and the timer 320 is used to measure or count, for example, the timeout duration in case of waiting for a response packet sent in response to a predetermined packet.

The CPU 314, the ROM 315, the RAM 316, the extension I/F control unit 318, the timer 320 and the network I/F control unit 319 are connected to the bus 317 in the network board 201. Further, the extension I/F control unit 318 is connected to the extension board bus 310 in the printer 202. The network I/F control unit 319 controls data input and output between the network board 201 and an external device through the LAN 200.

Incidentally, if the extension I/F control unit 318 is equipped with the controllable extension board bus 310, the network board 201 can be connected not only to the printer 202 but also to a facsimile machine, a copying machine, a multifunction machine or the like. In any case, by using the network board 201 like this, various devices can be set to be connected to the network such as the LAN 200 or the like.

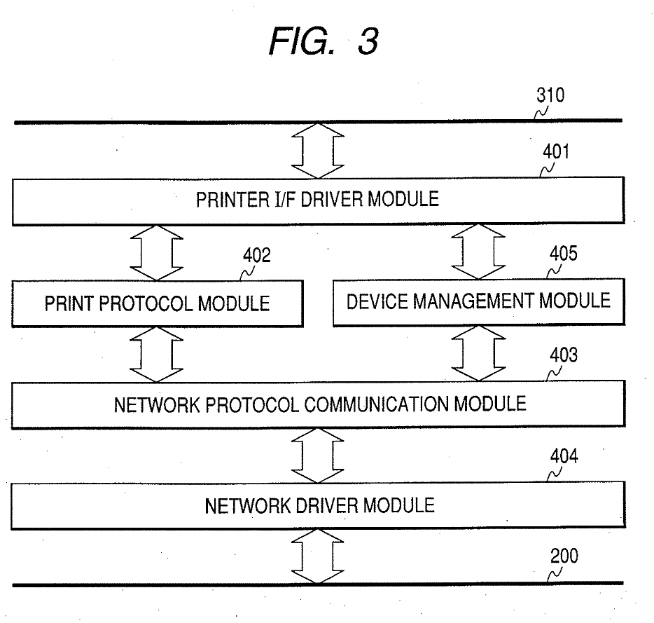

Next, an example of the constitution of the control program which is to be executed on the network board 201 will be explained. FIG. 3 is a diagram conceptually showing the example of the schematic constitution of the control program to be executed on the network board 201. In FIG. 3, a printer I/D driver module 401 is the module which is used to transmit and receive data to and from the printer 202 by controlling the extension I/F control unit 310, a print protocol module 402 is the module which is used to support a multi-purpose print protocol on the LAN 200, and a network protocol communication module 403 is the module which is used to execute the communication control on the LAN 200.

A network driver module 404 is the module which is used to actually transmit and receive a packet to and from the LAN 200 by controlling the network I/F control unit 319. Moreover, a device management module 405 is the module which communicates with the PC 203 connected to the LAN 200 so as to set and refer the information concerning the network board 201, and to set and refer the printer information.

The print protocol module 402 is the module which is used to receive, according to the print communication procedure defined by the protocol, the print data from the LAN 200 by using the network protocol communication module 403. Then, the received print data is transferred to the printer 202 through the printer I/F driver module 401. Further, a broadcast packet and a multicast packet are received by using the network driver module 404 and the network protocol communication module 403. Then, the received packet is transferred to the device management module 405 according to a kind of protocol.

In the network protocol communication module 403 according to the present embodiment, a TCP/IP (Transmission Control Protocol/Internet Protocol) is applied. Incidentally, it should be noted that the details of the respective items of the TCP/IP packet header and the system of the IP addresses are described in “Detailed Explanation of TCP/IP”; W. Richard Stevens (author), Naoji INOUE (supervisor and translator), and Yasuo TACHIBANA (translator); Softbank Corporation; First Edition published on Mar. 31, 1997. Further, it should be noted that the respective modules 401 to 405 illustrated in FIG. 3 are stored as the above-described control programs in the ROM 315 shown in FIG. 2. Then, the CPU 314 shown in FIG. 2 executes the respective modules 401 to 405, whereby the various functions of the network board 201 according to the present embodiment are achieved.

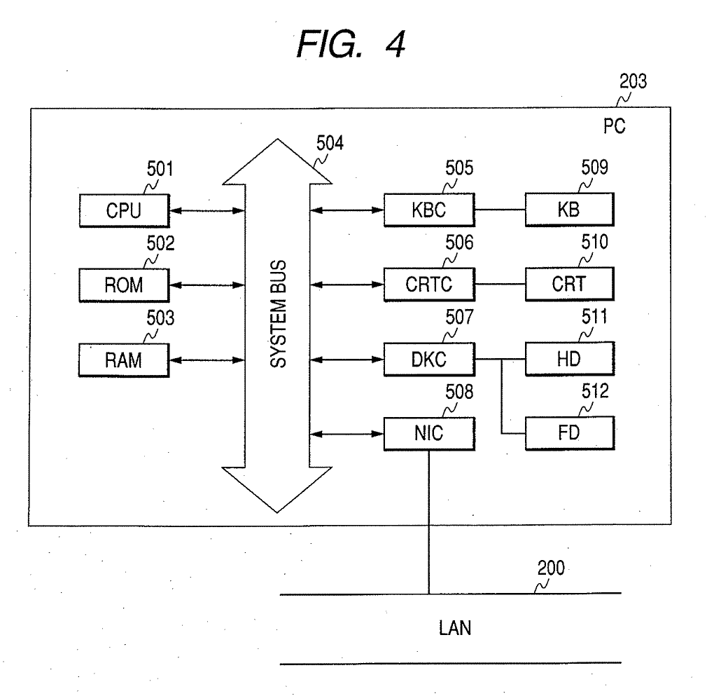

FIG. 4 is a block diagram showing an example of the constitution of the PC 203 which can operate the network management software. In FIG. 4, the PC 203 contains a CPU 501. More specifically, the CPU 501 activates and executes the network management software which is stored in a ROM 502 or an HD (hard disk) 511 or supplied from an FD (floppy™ disk drive). Thus, the CPU 501 totally controls the ROM 502, a RAM 503, a KBC (keyboard controller) 505, a CRTC (cathode ray tube controller) 506, a DKC (disk controller) 507, and an NIC (network interface card) 508.

The RAM 503 functions as the main memory, the working area and the like for the CPU 501, and the KBC 505 controls the instruction inputs from a KB (keyboard) 509, not-shown pointing devices and the like. The CRTC 506 controls the display operation of a CRT (cathode ray tube) 510, and the DKC 507 controls the accessing to the HD 511 and the FD 512 in which boot programs, various applications, editing files, user files, the network management software and the like have been stored. Further, the NIC 508 bidirectionally exchanges the data to/from an agent or a network device through the LAN 200.

Subsequently, the constitution of the network management device and the structure of the software will be explained. That is, the network management device is achieved by using the PC 203 shown in FIG. 4. The program of the network management software which is the agent of the operations in the later-described whole explanation with respect to the PC 203. In any case, unless otherwise noted, it is assumed that, in the following whole explanation, the agent for executing the processes in the PC 203 is the CPU 501 on the hardware. On the other hand, it is assumed that, in the PC 203, the agent for executing the control on the software is the network management software which has been stored in the HD 511. Moreover, it is assumed that, for example, Windows™ manufactured by Microsoft Co., Ltd. is used as an OS (operating system). However, it is of course possible to use another OS.

Incidentally, the network management software may be supplied in the form stored in a storage medium such as a flexible disk, a CD-ROM or the like. In this case, the program is read from the storage medium by the FD 512, a not-shown CD-ROM drive or the like, and the read program is then installed into the HD 511.

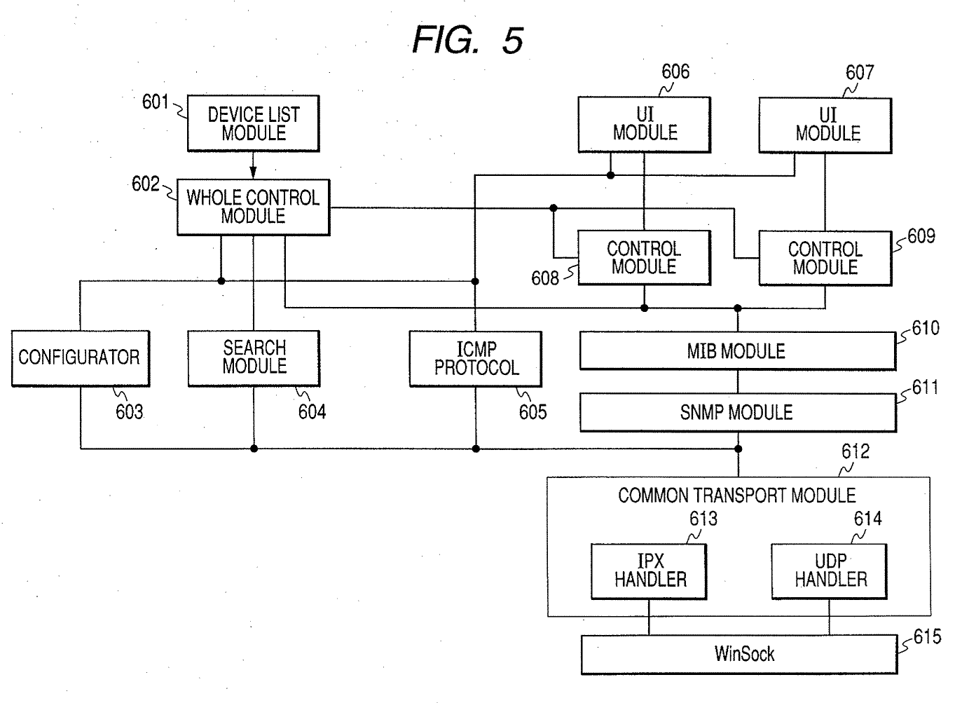

FIG. 5 is a block diagram showing an example of the module constitution of the network management software. As described above, the network management software is stored in the HD 511 shown in FIG. 4, and the stored software is then executed by the CPU 501. At this time, the CPU 501 uses the RAM 503 as the working area. In FIG. 5, a device list module 601 is the module which is used to display as a list the devices connected to the LAN (network) 200, and a whole control module 602 is the module which is used to totally control other modules on the basis of the indication issued from the device list module 601.

A configurator 603 is the module which is used to execute a specific process concerning the setting of the network in the network device. In particular, for example, in a case where the network device which is in the shipped state from the factory is first connected to the LAN 200, the configurator executes the setting for the network device according to the later-described specific protocol. Further, a search module 604 is the module which is used to search the network device connected to the LAN (network) 200. Then, the network devices which were searched by the search module 604 are listed and displayed by the device list module 601. Furthermore, an ICMP (Internet Control Message Protocol) module 605 is the module which is used to control an ICMP. Here, it should be noted that the ICMP is the protocol which is used to control the TCP/IP defined according to the RFC (Request For Comment) 792 by the IETF (Internet Engineering Task Force), and is normally installed in a terminal and a device in which the TCP/IP has been installed.

Here, UI (user interface) modules 606 and 607 are the modules which are used to display the later-described dialog box and the like, and exist with respect to each device of which the detailed information is displayed. Further, control modules 608 and 609 are the modules which act to execute the control which is specific with respect to the device of which the detailed information is acquired. As well as the UI modules 606 and 607, the control modules 608 and 609 exist with respect to each device of which the detailed information is displayed. Furthermore, the control modules 608 and 609 acquire MIB (Management Information Base) data from the management-target device by using an MIB module 610. Then, the control modules 608 and 609 convert the acquired data according to need, and transfer the converted data respectively to the corresponding UI modules 606 and 607.

Incidentally, the MIB module 610 is the module which is used to execute conversion between an object identifier and an object key. Here, it should be noted that the object key implies a 32-bit integer which one-to-one corresponds to the object identifier. Since the object identifier is the variable-length identifier, it is difficult to handle and manage the object identifier in the case where the network management software is installed. For this reason, in the network management software according to the present embodiment, the fixed-length identifier which one-to-one corresponds to the object identifier is internally used. Thus, the module which is superior to the MIB module 610 handles and manages MIB information by using the relevant object key. Incidentally, an SNMP (Simple Network Management Protocol) module 611 is the module which is used to transmit and receive an SNMP packet.

A common transport module 612 is the module which is used to absorb a different from the inferior protocol for transporting SNMP data. In fact, according to the protocol which is selected by a user at the time of operation, either an IPX (Internetwork Packet eXchange) handler 613 or a UDP (User Datagram Protocol) handler 614 acts to transfer the data. Incidentally, the UDP handler 614 actually uses a WinSock 615 (also called Windows™ sockets). Here, it should be noted that the WinSock 615 is the API (Application Program Interface) which is used to develop, by Windows™, the software for which the function of the TCP/IP is used. Incidentally, for example, the detail of the WinSock is described in the specification of “Windows™ Socket API v1.1”, and this specification is available by plural routes. For example, the relevant specification is bundled with “Visual C++” which is the compiler manufactured by Microsoft Co., Ltd.

Subsequently, a case where an independently set reference protocol according to the present embodiment is implemented by the TCP/IP will be explained. Incidentally, it should be noted that the independently set reference protocol according to the present embodiment is called a configurator protocol. Moreover, it is assumed that, in the present embodiment, the configurator protocol is implemented on a UDP (User Datagram Protocol).

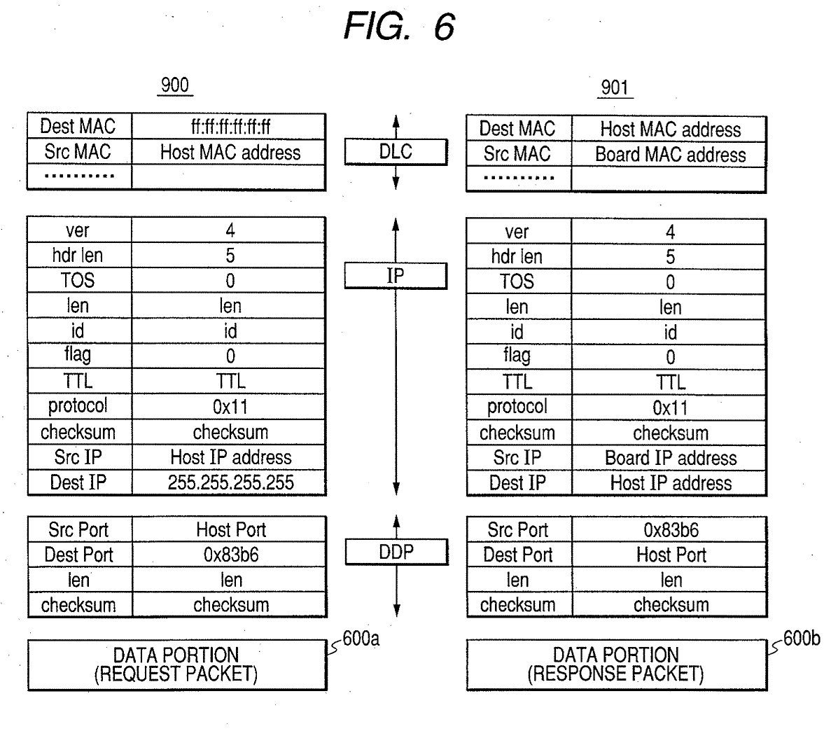

FIG. 6 is a diagram conceptually showing an example of the packet header of the packet (that is, each of a request packet 900 and a response packet 901) in the configurator protocol. More specifically, the configurator protocol uses the port number (Dest Port) “0x83b6” of the UDP. Moreover, it is assumed that the IP address (Dest IP) of the transmission destination in the request packet 900 is “255.255.255.255” and the MAC address (Dest MAC) of the transmission destination in the request packet 900 is “ff:ff:ff:ff:ff:ff”.

Here, it should be noted that the MAC address implies the physical address which is inherent to a device. Incidentally, if the network to be connected and used is the Ethernet™, the MAC address has the length of six bytes. In such a data structure of the MAC address, the forehand three bytes are allocated as a vendor code for data management under the rule of the IEEE, and the remaining three bytes are allocated for a code which is managed independently by each vendor (that is, managed and controlled so that two MAC addresses do not overlap each other). For this reason, it should be noted that two or more network devices which have the same physical address do not resultingly exist all over the world. In other words, it should be noted that a different physical address is allocated to each of all the network devices.

In any case, in the case where the MAC address of the transmission destination in the request packet 900 is “ff:ff:ff:ff:ff:ff”, the packet which includes this MAC address is managed and handled as the broadcast packet. Then, all the network devices which are connected to the LAN (network) 200 receive the relevant request packet 900. By the configurator protocol like this, the PC 203 can set, refer and reset the information concerning the network board 201. Moreover, the PC 203 can search the network device such as the network board 201 or the like.

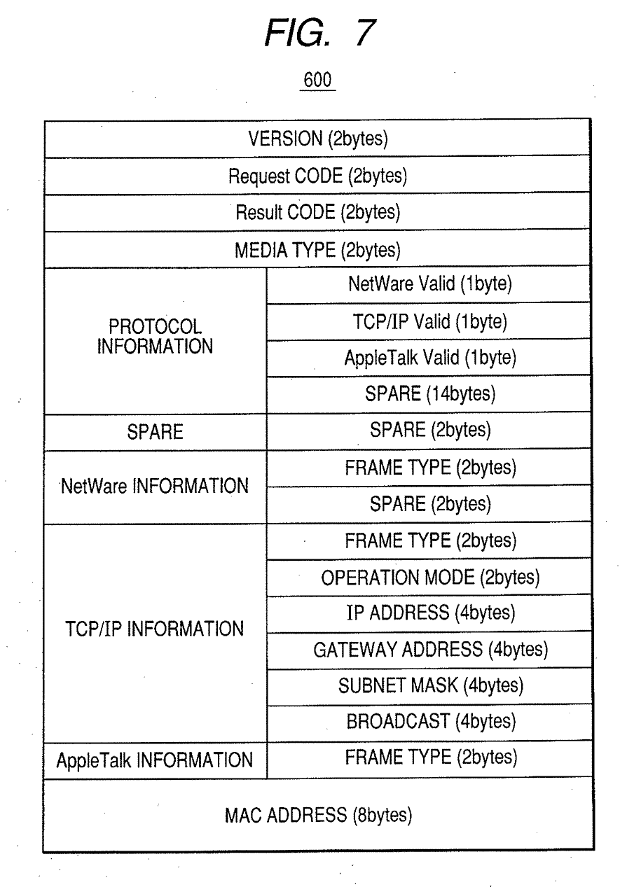

Subsequently, the data portion of each of the packets 900 and 901 in the configurator protocol will be explained. FIG. 7 is a diagram conceptually showing an example of the constitution of each of data portions 600a and 600b of the packet (that is, each of the request packet 900 and the response packet 901) in the configurator protocol shown in FIG. 6. Here, the details of respective parameters shown in FIG. 7 will be explained hereinafter.

(1) VERSION (Two Bytes)

The parameter “VERSION” indicates the version of the relevant packet. In this case, it is assumed that the version is “0x0300”.

(2) Request CODE

The parameter “Request CODE” indicates the codes of the functions requested by the relevant packet. In this case, it is assumed that “Request CODE” is as follows. incidentally, in the following, the code is shown at the left of “:” and the content of the relevant code is shown at the right of “:”.
0: Set (set)
1: Get (refer)
2: NVRAM—Reset (reset with NVRAM value)
3: Factory—Reset (reset with factory shipment value)
4: Discovery (search)

(3) Result CODE (Two Bytes)

The parameter “Result CODE” indicates the codes of the results requested. In this case, it is assumed that “Result CODE” is as follows.
0x0000: success
0x0001: Invalid media type
0x0002: Requested protocol is not supported
0x0003: Invalid version number
0xFFFF: Unknown error

(4) MEDIA TYPE (Two Bytes)

The parameter “MEDIA TYPE” indicates the communication medium or media. In this case, it is assumed that “MEDIA TYPE” is as follows.
0: Ethernet™

(5) PROTOCOL INFORMATION

The parameter “PROTOCOL INFORMATION” indicates the flags corresponding to the respective protocol information. For example, if “Result CODE” is “0” (that is, requesting setting), only the information concerning the protocol of which the corresponding byte is “1” is set.

(6) NetWare INFORMATION

The parameter “NetWare INFORMATION” indicates the information for setting and referring the information concerning the NetWare (one example of network management software). In this case, it is assumed that “NetWare INFORMATION” includes the frame type (two bytes) and the spare or reserve (two bytes). For example, if the LAN (network) 200 is the Ethernet™, the frame type to be used in the NetWare which is one example of the network management software is as follows.
0: Disable (NetWare is unusable)
1: 802.3
2: 802.2
4: Ethernet™ II
8: 802.2SNAP

(7) TCP/IP INFORMATION

The parameter “TCP/IP INFORMATION” indicates the information for setting and referring the information concerning the TCP/IP. In this case, it is assumed that “TCP/IP INFORMATION” includes a frame type (two bytes), an operation mode (two bytes), an IP address (four bytes), a gateway address (four bytes), a subnet mask (four bytes), and a broadcast (four bytes). For example, the frame type to be used in the TCP/IP is as follows.
0: Disable (TCP/IP is unusable)
4: Ethernet™ II

Moreover, for example, in a case where the operation mode is an IP mode, any one of the following values is set as the operation mode when referring the information.
0: IP address stored in NVRAM
1: BOOTP valid
2: RARP valid
4: DHCP valid

Here, the IP address (four bytes) indicates the IP address of the network board 201, the gateway address (four bytes) indicates the address of the gateway of the network board 201, the subnet mask (four bytes) indicates the subnet mask of the network board 201, and the broadcast address (four bytes) indicates the broadcast address of the network board 201.

(8) AppleTalk INFORMATION

The parameter “AppleTalk INFORMATION” indicates the information for setting and referring the information concerning the AppleTalk. In this case, it is assumed that “AppleTalk INFORMATION” is a frame type (two bytes). For example, the frame type to be used in the AppleTalk is as follows.
0: Disable (AppleTalk is unusable)
2: Phase 2

(9) MAC ADDRESS

The parameter “MAC ADDRESS” indicates the MAC address of the network board 201. Here, in a case where “Request CODE” is other than “4” (Discovery) and the value of the MAC address stored in the field of “MAC ADDRESS” does not conform to the value of the MAC address of the network board 201, this packet is ignored. Incidentally, it should be noted that each item in a data portion 600 shown in FIG. 7 is set to the factory shipment value which has been previously determined at the time of factory shipment.

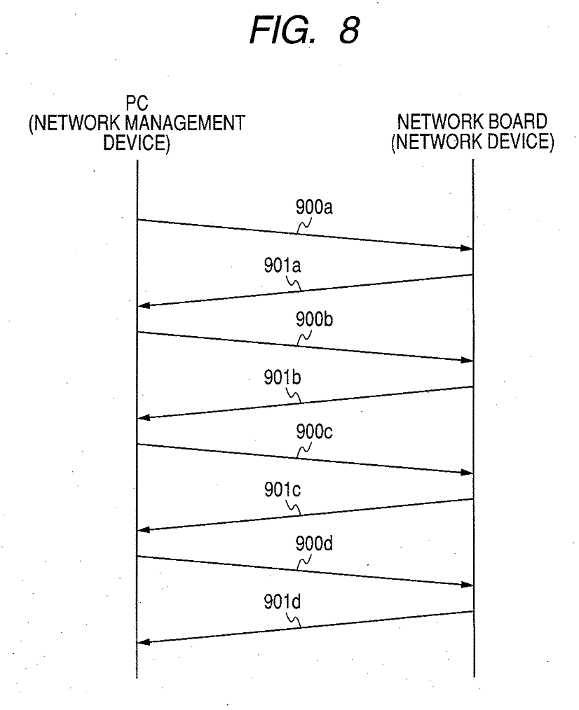

FIG. 8 is a diagram showing an example of the operations of the network management device (PC 203) and the network device (network board 201) in case of transmitting and receiving the configurator data packet. Incidentally, the operation of the PC 203 is achieved by executing the network management software stored in the HD 511 shown in FIG. 4, and the time axis longitudinally extends from the top to the bottom on FIG. 8.

First, in order to execute the network setting for the network board 201, the configurator 603 which has been booted up by the UI module 606 transmits a Discovery request packet 900a. Here, since the Discovery request packet 900a is the broadcast packet of “255.255.255.255” which is the IP address of the transmission destination as described above, the Discovery request packet 900a is transmitted to all the network devices which are connected to the same subnet.

If the network device (for example, the network board 201) which has the configurator protocol receives the Discovery request packet 900a, the relevant network device then transmits a Discovery response packet 901a to the PC 203. Subsequently, the Discovery response packet 901a is received by the configurator 603. After then, the configurator 603 stores the data portion of the received Discovery response packet 901a in the RAM 503.

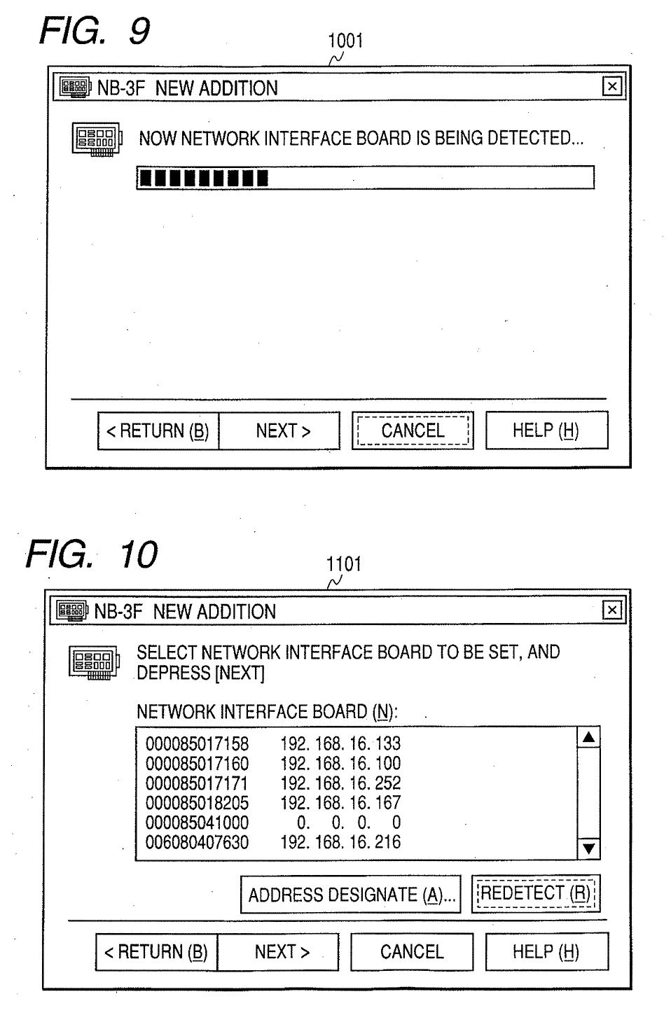

The configurator 603 executes the process for receiving the Discovery response packet 901a until a predetermined waiting time expires. While the process for receiving the Discovery response packet 901a is being executed, the UI module 606 executes the process for displaying a dialog box 1001 as shown in FIG. 9 on the CRT 510.

If the predetermined waiting time expires, the UI module 606 executes the process for closing the dialog box 1001. Then, the UI module 606 acquires the data portion of the received Discovery response packet 901a from the RAM 503. Subsequently, based on the acquired data portion of the Discovery response packet 901a, the UI module 606 creates the list which is used by the user to select the network board 201. For example, the created list includes the MAC address of the network board 201 and the information representing the current setting in the network board 201. Then, the UI module 606 executes the process for displaying on the CRT 510 a dialog box 1101 which includes the created list (see FIG. 10).

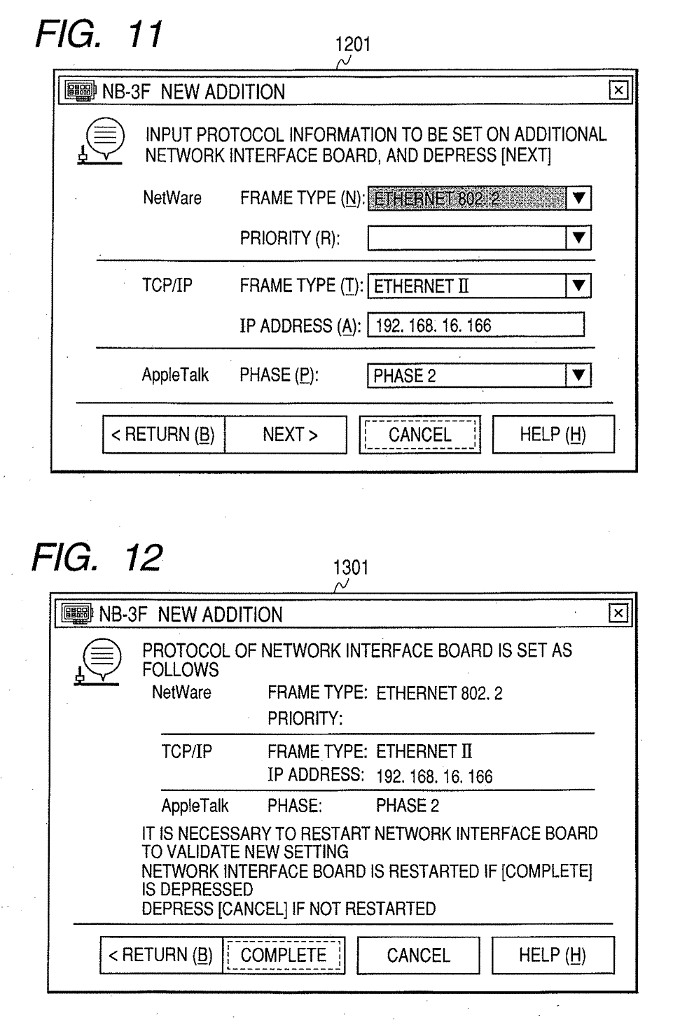

Subsequently, it waits until the arbitrary network board is selected in the dialog box 1101 shown in FIG. 10 or until the “REDETECT” button or the “CANCEL” button displayed in the dialog box 1101 is depressed or clicked by the user. If the “NEXT” button is depressed or clicked after any one of the network boards displayed in the list was selected by the user, the UI module 606 executes the process for displaying on the CRT 510 a dialog box 1201 as shown in FIG. 11. Here, the configurator 603 inputs the setting value of the network for the network board 201 selected by the user, generates a Set request packet 900b based on the input setting value, and transmits the generated Set request packet 900b to the network board 201.

Subsequently, the value which was input by the user is set in the field of “PROTOCOL INFORMATION” of the data portion of the Set request packet 900b, in the manner as described above. Moreover, the Set request packet 900b is put on the frame of which the destination is the MAC address acquired by the Discovery response packet 901a. For this reason, the Set request packet 900b is ignored on the boards other than the network board corresponding to the relevant MAC address. In other words, the Set request packet 900b is received only on the network board 201.

The network board 201 which received the Set request packet 900b causes the own configurator to set the various setting values defined in the data portion of the Set request packet 900b, in accordance with the configurator protocol. Thus, the setting of the network is completed on the network board 201. Then, the network board 201 transmits a Set response packet 901b to the PC 203 which acts as the network management device.

On the other hand, if the “CANCEL” button is depressed or clicked in the dialog box 1101 shown in FIG. 10, the UI module 606 deletes or cancels the list in the dialog box 1101 displayed on the CRT 506, and then ends the process. Moreover, if the “REDETECT” button is depressed or clicked, the UI module 606 again executes the broadcasting of the Discovery request packet 900a.

If the setting of the network is completed on the network board 201 and the Set response packet 901b is received, the UI module 606 executes the process to cause the CRT 510 to display a dialog box 1301 as shown in FIG. 12. After then, if the “COMPLETE” button in the dialog box 1301 is depressed or clicked by the user, a Reset request packet 900c and a Reset response packet 901c are exchanged between the PC 203 which acts as the network management device and the network board 201 which acts as the network device, so as to initialize the setting. Thus, the network board 201 is automatically reset, whereby it is thus possible to validate new setting. Incidentally, it is also possible to reset the network board 201 even if the Reset response packet 901c is not transmitted from the network board 201 to the PC 203.

In addition, in case of referring the setting of the network on the network board 201, a Get request packet 900d is transmitted from the PC 203 to the network board 201. Then, if the Get request packet 900d is received, the network board 201 generates, for example, the reference information representing the setting condition of the network on the network board 201. Subsequently, a Get response packet 901d which includes the generated reference information is transmitted from the network board 201 to the PC 203.

Incidentally, it should be noted that the timing of transmitting and receiving the Get request packet 900d and the Get response packet 901d is not limited to that shown in FIG. 8. For example, it is also possible to transmit and receive the Get request packet 900d and the Get response packet 901d during the period from the display of the dialog box 1101 shown in FIG. 10 to the display of the dialog box 1201 shown in FIG. 11.

More specifically, in that case, if the “NEXT” button in the dialog box 1101 shown in FIG. 10 is depressed or clicked by the user, the dialog box which urges the user to refer the setting of the network on the network board 201 is displayed instead of the dialog box 1201 shown in FIG. 11. Then, if it is designated to refer the setting of the network on the network board 201 on the basis of the user's operation for the displayed dialog box, the Get request packet 900d and the Get response packet 901d are transmitted and received between the PC 203 and the network board 201.

After then, on the basis of the reference information which is included in the Get response packet 901d, the PC 203 displays the dialog box which displays the content of the setting of the network on the network board 201. Subsequently, if the “NEXT” button in the displayed dialog box is depressed or clicked by the user who confirmed through the displayed dialog box the content of the setting of the network on the network board 201, the dialog box 1201 shown in FIG. 11 is displayed. By doing so, it is possible for the user to confirm the content of the current setting of the network on the network board 201 before the setting of the network on the network board 201 is changed, whereby it is preferable.

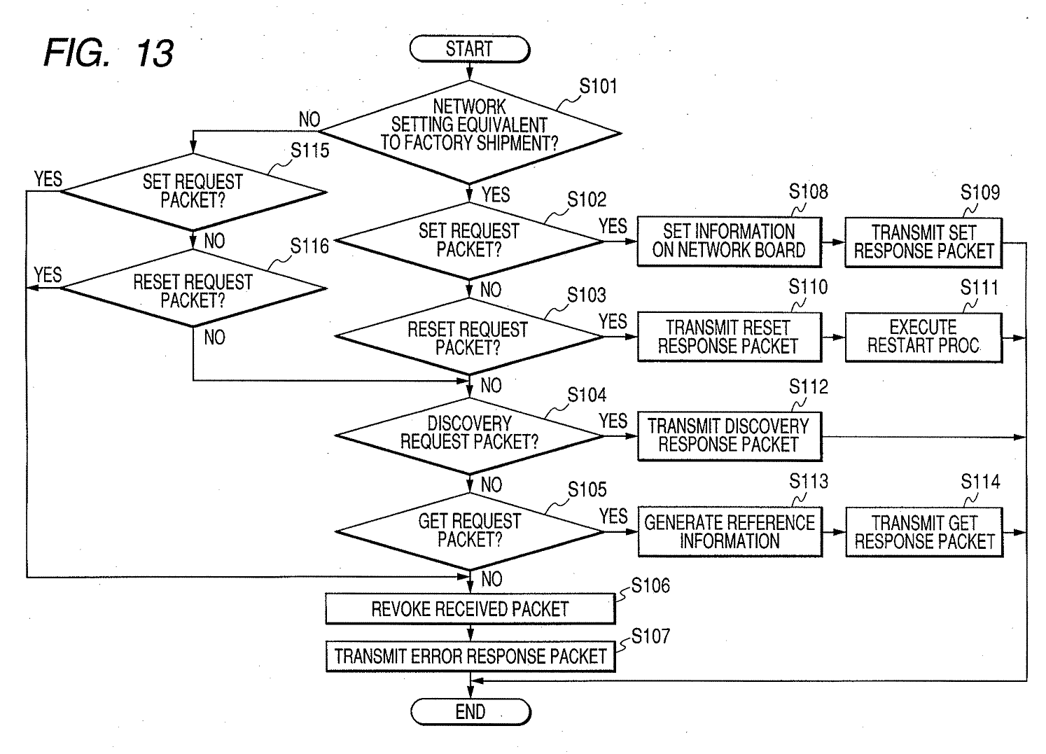

Subsequently, the operation of the network board 201 will be explained. FIG. 13 is a flow chart for explaining an example of the process which is executed by the device management module 405 provided on the network board 201. Here, the request packet (the broadcast packet or the multicast packet) 900 which is transmitted from the PC 203 is received by the network driver module 404 and the network protocol communication module 403. Then, if the received request packet 900 is based on the configurator protocol, the relevant request packet 900 is transferred to the device management module 405.

In the present embodiment, since the configurator protocol is achieved by the TCP/IP, the request packet (the broadcast packet) 900 based on the configurator protocol has the packet format as shown in FIG. 6. Therefore, if the protocol type of the request packet 900 is the UDP (that is, “protocol” in the packet header shown in FIG. 6 is “0x11”) and the port number (that is, “Dest Port” in the packet header shown in FIG. 6) is “0x83b6”, the network protocol communication module 403 judges that the relevant request packet 900 is based on the configurator protocol. Then, the request packet 900 is transferred to the device management module 405.

First, in a step S101 shown in FIG. 13, it is judged by the device management module 405 whether or not the setting of the network on the network board 201 has been changed from the factory shipment value. In other words, it is judged whether or not the setting of the network has been already changed, according to the method of changing the setting of the network by using the configurator protocol or the method of changing the setting of the network by using the operation panel consisting of the LCD 312, the keypad 313 and the like. In practice, it is judged in the step S101 whether or not the setting of the network is equivalent to the factory shipment value.

For example, in a case where the network device has the IP address “0.0.0.0” which is the factory shipment value, if the IP address other than “0.0.0.0” is found or detected, it is judged that the setting of the network has been changed. Then, as a result of the judgment in the step S101, if the setting of the network is not changed from the factory shipment value (that is, if “YES” in the step S101), the flow advances to a step S102. On the other hand, if the setting of the network has been changed from the factory shipment value (that is, if “NO” in the step S101), the flow advances to a step S115.

Then, it is judged in the step S102 whether or not the value of “Request CODE” in the data portion 600a of the request packet 900 is “0”. In other words, it is judged whether or not the received request packet is the Set request packet 900b which requests the setting (see FIGS. 6 to 8). Then, as a result of the judgment, if the value of “Request CODE” in the data portion 600a of the request packet 900 is “0” (that is, if “YES” in the step S102), the flow advances to a step S108. On the other hand, if the value of “Request CODE” in the data portion 600a of the request packet 900 is not “0” (that is, if “NO” in the step S102), the flow advances to a step S103.

Subsequently, in the step S108, the (various kinds of) information on the network board 201 is set (changed) on the basis of the setting information which was sent from the PC 203 (the network management software). Next, in a step S109, the Set response packet 901b is transmitted to the PC 203 as the response to the setting request.

Incidentally, if the value of “Request CODE” in the data portion 600a of the request packet 900 is not “0” (that is, if “NO” in the step S102), the flow advances to the step S103. In the step S103, it is judged whether or not the value of “Request CODE” in the data portion 600a of the request packet 900 is “2” or “3”. In other words, it is judged whether or not the received request packet is the Reset request packet 900c which requests the resetting (see FIGS. 6 to 8). Then, as a result of the judgment, if the value of “Request CODE” in the data portion 600a of the request packet 900 is “2” or “3” (that is, if “YES” in the step S103), the flow advances to a step S110. On the other hand, if the value of “Request CODE” in the data portion 600a of the request packet 900 is not “2” or “3” (that is, if “NO” in the step S103), the flow advances to a step S104.

In the step S110, the Reset response packet 901c for the request of the resetting is transmitted to the PC 203. Next, in a step S111, resetting of the network board 201 is executed (that is, a restart process is executed). At that time, if the value of “Request CODE” in the data portion of the Reset request packet 900c is “2”, the resetting is executed by setting the initial value to the NVRAM value. On the other hand, if the value of “Request CODE” in the data portion of the Reset request packet 900c is “3”, the resetting is executed by setting the initial value to the factory shipment value.

Meanwhile, if it is judged in the step S103 that the value of “Request CODE” in the data portion 600a of the request packet 900 is not “2” or “3” (that is, if “NO” in the step S103), the flow advances to the step S104. Then, it is judged in the step S104 whether or not the value of “Request CODE” in the data portion 600a of the request packet 900 is “4”. In other words, it is judged whether or not the received request packet is the Discovery request packet 900a which requests the searching (see FIGS. 6 to 8).

Then, as a result of the judgment, if the value of “Request CODE” in the data portion 600a of the request packet 900 is “4” (that is, if “YES” in the step S104), the flow advances to a step S112. In the step S112, the Discovery response packet 901a for the request of searching is transmitted to the PC 203. On the other hand, if the value of “Request CODE” in the data portion 600a of the request packet 900 is not “4” (that is, if “NO” in the step S104), the flow advances to a step S105. Then, it is judged in the step S105 whether or not the value of “Request CODE” in the data portion 600a of the request packet 900 is “1”. In other words, it is judged whether or not the received request packet is the Get request packet 900d which requests the referring (see FIGS. 6 to 8). As a result of the judgment, if the value of “Request CODE” in the data portion 600a of the request packet 900 is “1” (that is, if “YES” in the step S105), the flow advances to a step S113. On the other hand, if the value of “Request CODE” in the data portion 600a of the request packet 900 is not “1” (that is, if “NO” in the step S105), the flow advances to the step S106.

Next, the reference information is generated in the step S113. Subsequently, in a step S114, the generated reference information is stored in the Get response packet 901d, and the acquired Get response packet 901d is transmitted to the PC 203.

On the other hand, if it is judged in the step S105 that the value of “Request CODE” in the data portion 600a of the request packet 900 is not “1” (that is, if “NO” in the step S105), the flow advances to a step S106. In the step S106, the received request packet is revoked or discarded as a request incapable of being processed. Subsequently, in a step S107, an error response packet is transmitted to the PC 203.

Incidentally, if it is judged in the step S101 that the setting of the network has been changed from the factory shipment value (that is, if “NO” in the step S101), the flow advances to the step S115. In the step S115, it is judged whether or not the value of “Request CODE” in the data portion of the request packet 900 is “0”. In other words, it is judged whether or not the received request packet is the Set request packet 900b which requests the setting. Then, as a result of the judgment, if the value of “Request CODE” in the data portion 600a of the request packet 900 is “2” (that is, if “YES” in the step S115), the flow advances to the step S106. On the other hand, if the value of “Request CODE” in the data portion 600a of the request packet 900 is not “0” (that is, if “NO” in the step S115), the flow advances to a step S116.

In the step S116, it is judged whether or not the value of “Request CODE” in the data portion 600a of the request packet 900 is “2” or “3”. In other words, it is judged whether or not the received request packet is the Reset request packet 900c which requests the resetting. Then, as a result of the judgment, if the value of “Request CODE” in the data portion 600a of the request packet 900 is “2” or “3” (that is, if “YES” in the step S116), the flow advances to the step S106. On the other hand, if the value of “Request CODE” in the data portion 600a of the request packet 900 is not “2” or “3” (that is, if “NO” in the step S116), the flow advances to the step S104.

Incidentally, it should be noted that, in the present embodiment, the device management module 405 and the control program for causing the CPU 314 shown in FIG. 2 to operate as the SNMP agent are stored in the ROM 316. The control program which is used in case of executing the process shown in the flow chart of FIG. 13 is executed by the CPU 314 which concretely acts as the device management module 405. Moreover, to again validate the change of the setting of the network by the configurator protocol can be achieved by returning the setting of the network on the network board 201 to the factory shipment value with use of the operation panel.

As described above, according to the present embodiment, in the case where the request packet from the PC 203 is based on the configurator protocol, the device management module 405 which is one of the modules of the control program for the network board 201 judges whether or not the setting of the network has been changed from the factory shipment value. Then, in the case where it is judged that the setting of the network has been changed from the factory shipment value, even if the setting or resetting of the network board 201 is requested by the request packet, the device management module 405 is set not to execute the process for the relevant request. Thus, it is possible to prevent that the setting of the network of the printer 202 (that is, the network device) is changed or reset by a user who does not have any authority.

Incidentally, in the present embodiment, in the case where the setting of the network has been changed from the factory shipment value, it is set not to execute the process for the setting request and the resetting request to the network device. However, the present invention is not limited to this. For example, in the case where the setting of the network has been changed from the factory shipment value, it is possible to set not to execute a process for the searching request or the reference request.

Moreover, in the present embodiment, in the case where the setting of the network by the configurator packet has been changed from the factory shipment value, it is set not to execute the process for the setting request and the resetting request to the network device. However, the present invention is not limited to this. For example, by using the operation panel consisting of the LCD 312, the keypad 313 and the like, it is possible to set not to execute a process for the setting request and the resetting request for the network device even if the setting of the network has been changed from the factory shipment value.

Moreover, the present embodiment may be applied to a system which is constituted by using plural devices (for example, a host computer, an interface device, a reader, a printer, and the like), as well as to an apparatus which consists of a single device (for example, a copy machine, a facsimile machine, or the like). Besides, in the present embodiment, the case where the network board 201 and the printer 202 are independently provided is explained by way of example. However, the present invention is not limited to this. That is, the network board 201 may be incorporated in the printer 202.

(Other Embodiments of the Present Invention)

Moreover, it is also possible to supply the program code of software for achieving the functions of the above embodiment to the computer which is provided in the apparatus or the system connected to various kinds of devices so as to operate these devices to achieve the functions of the above embodiment. In this connection, the present invention also includes the case of causing to operate the above various kinds of devices according to the program stored in the computer (or CPU or MPU) of the relevant system or the relevant apparatus.

In that case, the program code itself of the software achieves the functions of the above embodiment. Thus, the relevant program code itself and the means for supplying the program code to the computer (for example, a recording medium which stores thereon the program code) constitute the present invention. Here, the recording medium for storing the program code may be, for example, a flexible disk, a hard disk, an optical disk, a magnetooptical disk, a CD-ROM, a CD-R, a magnetic tape, a nonvolatile memory card, a ROM, or the like.

Further, it can be obviously understood that, also in a case where the program codes cooperates with the OS (operating system) running on the computer or another application software to achieve the functions of the above embodiment, the relevant program code is included in the embodiment of the present invention.

Furthermore, it can be obviously understood that the present invention also includes a case where, after the supplied program code is stored in the memory which is provided in the function extension board inserted in the computer or in the function extension unit connected to the computer, the CPU or the like which is provided in the function extension board or in the function extension unit executes a part or all of the actual processes on the basis of the instructions of the program code, and thus the functions of the above embodiment are achieved by these processes.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-265907, filed Sep. 13, 2005 which is hereby incorporated by reference herein in its entirety.

What is claimed is:

1. A device comprising:
a reception unit adapted to receive a specific request transmitted from an information processing device on a network;
a first judgment unit adapted to judge whether or not setting concerning the network in said device has been changed; and
a control unit adapted to not execute a process for the specific request received by said reception unit in a case where it is judged by said first judgment unit that the setting concerning the network has been changed, and to execute the process for the specific request received by said reception unit in a case where it is judged by said first judgment unit that the setting concerning the network is not changed.

2. A device according to claim 1, further comprising a second judgment unit adapted to judge whether or not the specific request is a packet transmitted to a predetermined port number of said device,
wherein said first judgment unit judges whether or not the setting concerning the network in said device has been changed in a case where it is judged by said second judgment unit that the request is the packet transmitted to the predetermined port number of said device.

3. A device according to claim 1, further comprising a third judgment unit adapted to judge whether or not the specific request is a first request,
wherein, in a case where it is judged by said first judgment unit that the setting concerning the network has been changed and it is further judged by said third judgment unit that the specific request is the first request, said control unit does not execute the process for the request received by said reception unit, and
in a case where it is judged by said first judgment unit that the setting concerning the network has been changed and it is further judged by said third judgment unit that the specific request is not the first request, said control unit executes the process for the specific request received by said reception unit.

4. A device according to claim 3, wherein the first request includes a setting request or a reset request for the setting concerning the network in said device.

5. A device according to claim 1, further comprising an execution unit adapted to restart said device after the execution of the process for the specific request.

6. A device according to claim 1, further comprising an error notification unit adapted to notify the information processing device of an error in a case where said control unit does not execute the process for the specific request.

7. A device according to claim 1, further comprising a result notification unit adapted to notify the information processing device of a process result after the execution of the process for the specific request.

8. A device according to claim 1, wherein said first judgment unit judges whether or not the setting concerning the network in said device has been changed from a factory shipment value thereof.

9. A device according to claim 1, wherein the setting concerning the network in said device includes an IP address of said device.

10. A device according to claim 1, wherein said device is any one of a printer, a facsimile machine, a copying machine and a multifunction machine.

11. A data processing method comprising:
a reception step of receiving a specific request transmitted from an information processing device on a network;
a judgment step of judging whether or not setting concerning the network in a device has been changed; and
a control step of not executing a process for the specific request received in said reception step in a case where it is judged in said judgment step that the setting concerning the network has been changed, and of executing the process for the specific request received in said reception step in a case where it is judged in said judgment step that the setting concerning the network is not changed.

12. A computer-readable recording medium which stores therein a program for causing a computer to execute:
a reception step of receiving a specific request transmitted from an information processing device on a network;
a judgment step of judging whether or not setting concerning the network in a device has been changed; and
a control step of not executing a process for the specific request received in said reception step in a case where it is judged in said judgment step that the setting concerning the network has been changed, and of executing the process for the specific request received in said reception step in a case where it is judged in said judgment step that the setting concerning the network is not changed.
